(19) United States
(12) Patent Application Publication
(10) Pub. No.: US 2011/0049131 A1
(43) Pub. Date: Mar. 3, 2011

(54) HORSE BIT WARMER

(76) Inventor: Jamie K. Sturgess, Hampstead, NH (US)

(21) Appl. No.: 12/868,407

(22) Filed: Aug. 25, 2010

Related U.S. Application Data
(60) Provisional application No. 61/236,868, filed on Aug. 25, 2009.

(51) Int. Cl. H05B 3/02

(52) U.S. Cl. 219/549

(57) ABSTRACT

The bit warmer has a carbon heating element that is contained within a water resistant polyvinyl chloride (PVC) cover. The carbon heating element has an electrical plug connected to it. Optionally, a piece of insulation is adhesively attached to the carbon heating element. The carbon heating element is then placed in a nylon fabric pouch. The nylon fabric pouch is fastened by a hook and loop fastener. The encased carbon heating element is plugged into an available outlet, then wrapped around the bit. The pouch containing the carbon heating element is then fastened so that the bit is enveloped by the pouch.

### RELATED APPLICATIONS

This application claims the benefit of U.S. Provisional Patent Application Ser. No. 61/236,868 filed Aug. 25, 2009, which is herein incorporated in its entirety by reference.

### TECHNICAL FIELD

The present invention relates generally to the field of horse tack accessories. More particularly, the invention relates to a device that warms a bit for a horse.

### BACKGROUND

A bit is a device placed in a horse's mouth, kept on a horse's head by means of a headstall. There are many types, each useful for specific types of riding and training. The mouthpiece of the bit does not rest on the teeth of the horse, but rather rests on the gums or “bars” of the horse's mouth in an interdental space behind the front incisors and in front of the back molars. It is important that the style of bit is appropriate to the horse's needs and is fitted properly for it to function properly and be as comfortable as possible for the horse.

Horse bridle bits are commonplace riding equipment used by the majority of equestrians for purposes of controlling and directing a horse as it is ridden. Bridle bits are conventionally made from stainless steel or a combination of metals which inherently exhibit relatively high thermal conductivity and thus tend to assume the same temperature as the ambient temperature within a stable. Unfortunately, the average equestrian facilities are typically unheated, such that the metal mouth piece of the bridle quickly assumes the temperature of the surrounding room, with the unpleasant result that the bit can generate a strong sensation of cold when placed into the mouth of the horse. This cold sensation can frequently be a shock to the horse, causing discomfort and recoil.

Horse trainers agree that an ice cold bit can make a horse bit-shy, resistant to and/or afraid of being bridled, or might even injure the horse's gums, tongue, and lips. One method of warming a bit is to dip it into a bucket of hot water for a minute or two. Another method is to wrap the bit in a warm wet washcloth. Yet another method of warming the bit is for the rider to place it in their hands and to breathe on it. Alternatively, the rider could place it inside their shirt, pants or other area of clothing. The disadvantages of these methods are that they require a physical action from the rider. Riders have also used a method wherein they place the bit in front of the vent of a car heater. The disadvantage here is that the rider's vehicle may not be in the vicinity of the barn where the horse is being tacked.

There are other bit warmer devices. One is an electrical unit that mounts to the wall of a barn. Another is a chemical gel pack that requires manual activation by kneading, then reactivation by boiling it in hot water or microwaving it. Other warmers contain non toxic materials that still require activation by microwaving. The disadvantages of these devices are that barns are often not equipped with hot water, hot plates, stoves, or microwave ovens to activate and/or reactivate the gel pack. As a result, the gel pack does not retain enough heat to warm the bit once the rider has transported it to the barn from the location where it has been activated and/or reactivated. Another disadvantage is that the gel pack may potentially leak chemicals if damaged. All of these devices also have the disadvantage of being inconvenient, environmentally unfriendly and/or have a significant ongoing operating expense.

Thus, there is a need for bit warmer device that allows a user to tack a horse quickly and efficiently without discomfort to the person or the horse. There is also a need for an alternative device which can be repeatedly used easily, reliably, and inexpensively to warm a bridle bit to a suitable temperature compatible with a horse's body temperature.

### SUMMARY

It is a goal of the present invention to provide a bit warmer device that is easy to transport, reusable, and non toxic.

It is another goal of the present invention to provide a bit warmer device that does not require the user to be in physical contact with the bit.

It is yet another goal of the present invention to provide a bit warmer that does not require manual activation on the part of the user.

It is a further goal of the present invention to provide a bit warmer that does not require activation of an external heat source.

Accordingly, such a bit warmer is provided. The bit warmer has a carbon heating element that is contained within a water resistant polyvinyl chloride (PVC) cover. The carbon heating element has an electrical plug connected to it. Optionally, a piece of insulation is adhesively attached to the carbon heating element. The carbon heating element is then placed in a nylon fabric pouch. The nylon fabric pouch is fastened by a hook and loop fastener. The encased carbon heating element is plugged into an available outlet, then wrapped around the bit. The pouch containing the carbon heating element is then fastened so that the bit is enveloped by the pouch.

The present invention is a simple, convenient, and easy-to-use device for achieving a warmed temperature of a cold steel horse bit that's compatible with a horse's normal body temperature. The bit warmer of the present invention is a self contained unit made with an electronically powered heating pad as its heat source which is insulated with a foam tube and covered in a nylon material. The bit warmer opens at the center of the tube and a cold bit can be laid across the center of the tube. The tube is then secured around the bit with a closure strap and the heating element is then plugged in. Within minutes, while the rider is grooming, saddling up, and preparing their horse for their ride, the cold bit is being warmed to a comfortable temperature for the horse.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

The invention will be better understood and features and advantages, other than those set forth above, will become apparent when consideration is given to the following detailed description thereof. Such description makes reference to the annexed drawings wherein:

FIG. 1 is a rear view of the bit warmer of the present invention in an open position.

FIG. 2 is a front view of the bit warmer of the present invention in an open position.

FIG. 3 is a right front view of the bit warmer of the present invention in a closed position.

FIG. 4 is a left front view of the bit warmer of the present invention in a closed position.

FIG. 5 is a front view of the bit warmer of the present invention wrapped around a bit.

FIG. 6 is a perspective view of the bit warmer of the present invention.

FIG. 7 is an exploded view of the bit warmer of the present invention illustrating the relationship between the carbon heating element and the pouch.

### DETAILED DESCRIPTION

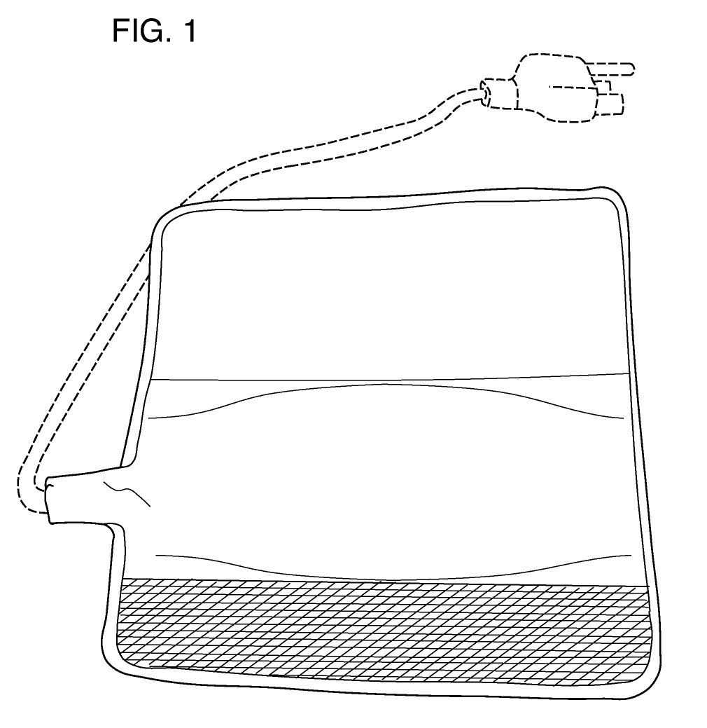

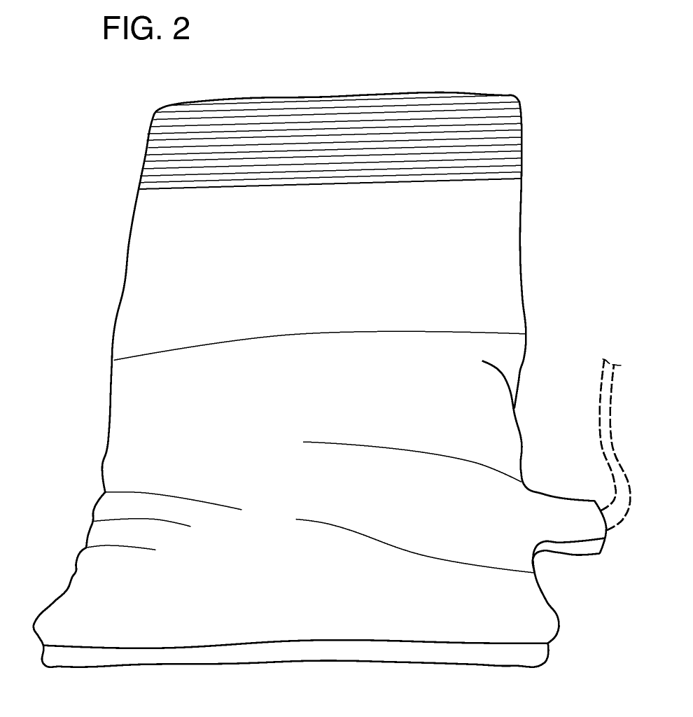

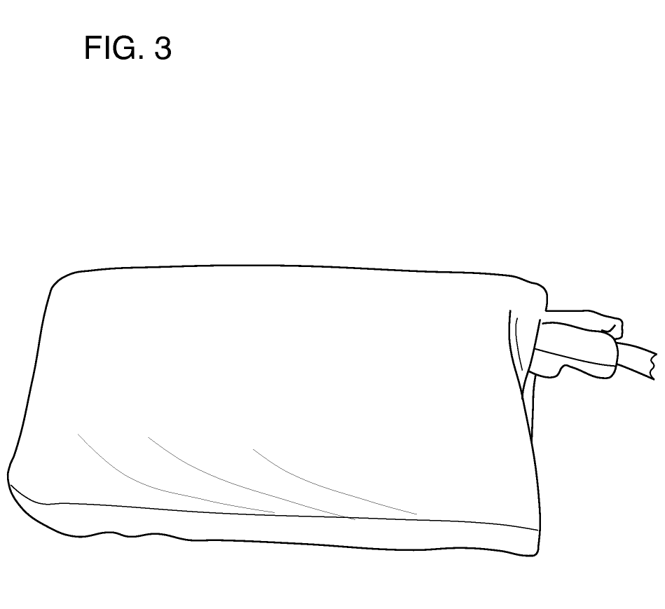

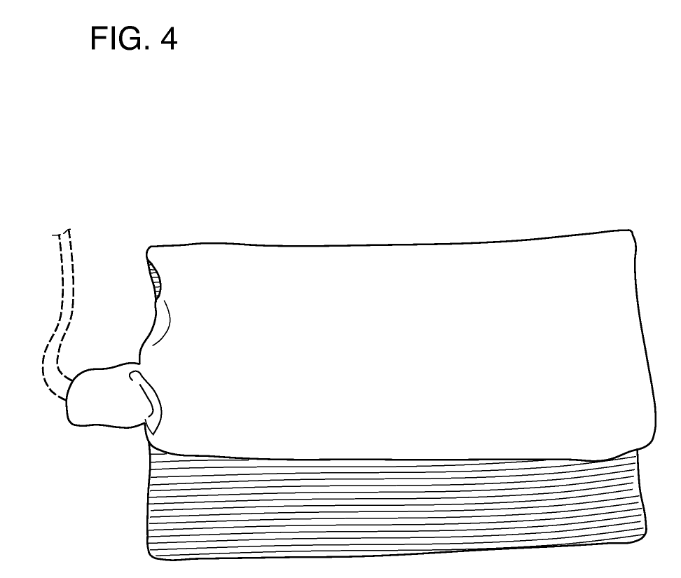

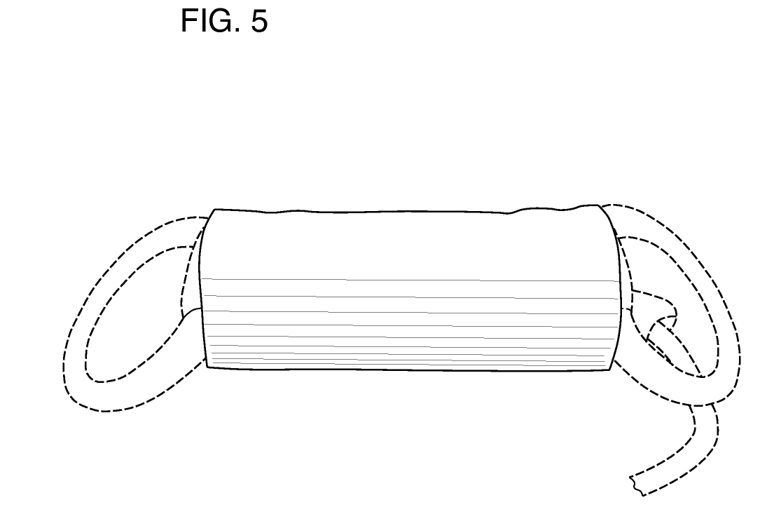

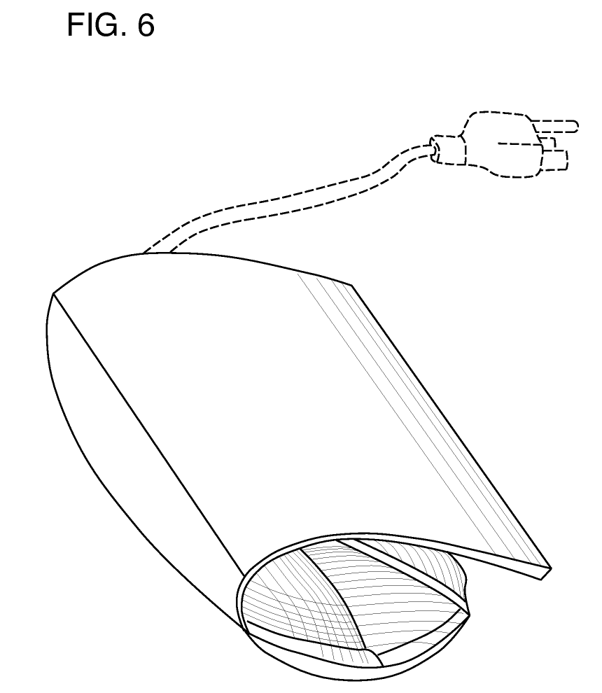

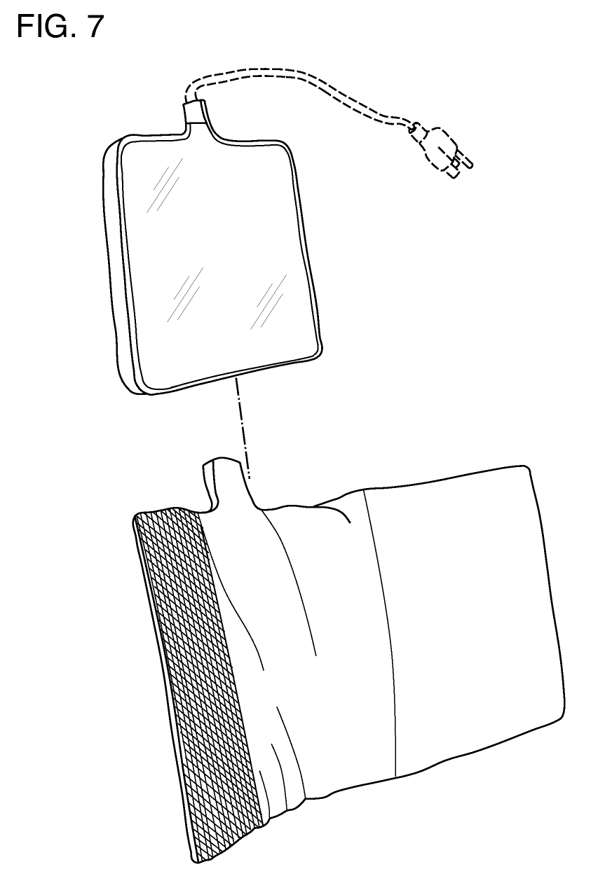

Referring to the drawings in general and to FIGS. 1-7 in particular, there is provided a bit warmer 100. Bit warmer 100 has a carbon heating element 10 that is contained within a water resistant polyvinyl chloride (PVC) cover. Carbon heating element 10 has an electrical plug connected to it. Alternatively, other power sources, such as batteries, may be used. The wattage of carbon heating element 10 may range from 4 to 10 watts. In an alternative embodiment, a piece of insulation (not shown) is adhesively attached to carbon heating element 10. Carbon heating element 10 is then placed in a nylon pouch 20 as shown in FIG. 7. Pouch 20 may be made of other fabrics, such as cotton, polyester, microfiber, suede, imitation leather, leather, and/or vinyl. The fabrics may be natural or synthetic. Referring to FIGS. 1 and 2, pouch 20 has an exterior side 22 and an interior side 24. Pouch 20 is secured by a hook and loop fastener 25. As shown in FIG. 1, the loop portion of fastener 25 is positioned on a bottom edge of exterior side 22 of pouch 20. As seen in FIG. 2, the hook portion of fastener 25 is positioned on a top edge of interior side 24 of pouch 20. The pouch may be secured by other means, such as snaps, zippers, and/or buttons. Referring to FIGS. 3, 4, and 6, pouch 20 is tri-folded. Referring to FIG. 5, the encased carbon heating element is plugged into an available outlet, then wrapped around the mouth piece of the bit. Pouch 20 containing 10 carbon heating element 10 is then fastened so that the bit is enveloped by pouch 20. Bit warmer 100 fits all types and sizes of bridle bits.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A device for warming a bit for a horse comprising:
a carbon heating element, the carbon heating element being encased within a water resistant cover;
a pouch, wherein the pouch houses the carbon heating element, and wherein the pouch has an exterior side and an interior side.

2. The device of claim 1 further comprising a piece of insulation positioned between the carbon heating element and the pouch.

3. The device of claim 1 wherein the carbon heating element has an adhesive backing for attachment to the piece of insulation.

4. The device of claim 1 wherein the pouch is made of a fabric, the fabric being selected from the group consisting of natural fibers, synthetic fibers, and a combination thereof.

5. The device of claim 4 wherein the fabric is selected from the group consisting of nylon, cotton, polyester, microfiber, suede, imitation leather, leather, vinyl, and a combination thereof.

6. The device of claim 1 wherein the pouch has a fastening element, the fastener element being selected from the group consisting of a hook and loop fastener, zipper, buttons, snaps, and a combination thereof.

7. The device of claim 6 wherein one piece of the fastener element is positioned on a bottom edge of the exterior side of the pouch and a corresponding piece of the fastener element is positioned on a top edge of the interior side of the pouch.
